(19) United States
(12) Patent Application Publication
(10) Pub. No.: US 2011/0253849 A1
(43) Pub. Date: Oct. 20, 2011

(54) FASTENING DEVICE FOR BICYCLE SEAT PAD AND SEAT TUBE USING THE SAME

(75) Inventor: CHIH-MING CHEN, Taichung County (TW)

(73) Assignee: YEU CHUEH INDUSTRY CO., LTD, Taichung County (TW)

(21) Appl. No.: 12/780,859

(22) Filed: May 14, 2010

(30) Foreign Application Priority Data
Apr. 20, 2010 (TW) 099207148

(51) Int. Cl. B62J 1/08; F16L 41/12

(52) U.S. Cl. 248/158; 285/197

(57) ABSTRACT

The fastening device of the present invention includes a base, two pawl shanks and two positioning rods. The base is formed with two hook portions and two base positioning holes. Each pawl shank is formed with a pawl positioning hole, and each pawl shank includes a pawl section and a hook section. Each positioning rod inserts in one of the base positioning holes and the pawl positioning hole of one of the pawl shanks, such that the pawl shanks are pivotable about the positioning rods respectively. Each hook portion and its corresponding hook section define a pad clamp, and the pawl sections define a tube clamp. The fastening device further includes a means for narrowing the pad clamps and the tube clamp.

### BACKGROUND OF THE INVENTION

1. Field of the Invention

The present invention relates to a fastening device for a bicycle seat pad, and to a seat tube using the fastening device.

2. Description of the Prior Art

A seat tube of the bicycle is adapted for a seat pad to dispose thereon. To install the seat pad, a fastening device is needed as disclosed in TW M289401. The fastening device mainly includes a middle shank and two side shanks, and two engaging spaces are defined between the middle shank and the side shanks respectively. Thus when the side shanks are urged toward each other, the bottom tubes of the seat pad can be tightly clamped in the engaging spaces respectively.

However, there is still one disadvantage that it is not convenient for a user to hold the middle shank and the side shanks simultaneously with one hand while threading a screw through these shanks with the other hand.

The present invention is, therefore, arisen to obviate or at least mitigate the above mentioned disadvantages.

### SUMMARY OF THE INVENTION

The main object of the present invention is to provide an easy-installed fastening device for a bicycle seat pad.

To achieve the above and other objects, the fastening device of the present invention includes a base, two pawl shanks and two positioning rods. The base is formed with two hook portions and two base positioning holes. Each pawl shank is formed with a pawl positioning hole and includes a pawl section and a hook section. Each positioning rod inserts in one of the base positioning holes and the pawl positioning hole of one of the pawl shanks, such that the pawl shanks are pivotable about the positioning rods respectively. Further, each hook portion and its corresponding hook section define a pad clamp, and the pawl sections define a tube clamp. The fastening device further includes a means for narrowing the pad clamps and the tube clamp.

Due to the positioning rods, the pawl shanks of the present invention are pivotable and can be easily held by the user. The installation of the seat pad is, therefore, facilitated.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective drawing showing a seat tube of the present invention;

FIG. 1A is a partial enlargement drawing of FIG. 1;

FIG. 2 is a breakdown drawing showing a seat tube of the present invention;

FIG. 3 is a breakdown drawing showing another seat tube of the present invention;

FIG. 4 is a profile showing a seat tube of the present invention.

### DETAILED DESCRIPTION OF THE PREFERRED EMBODIMENTS

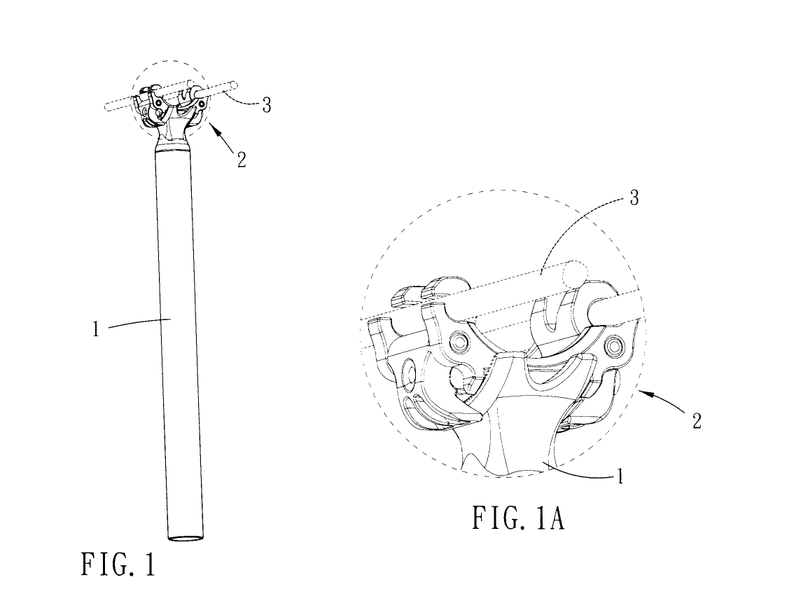

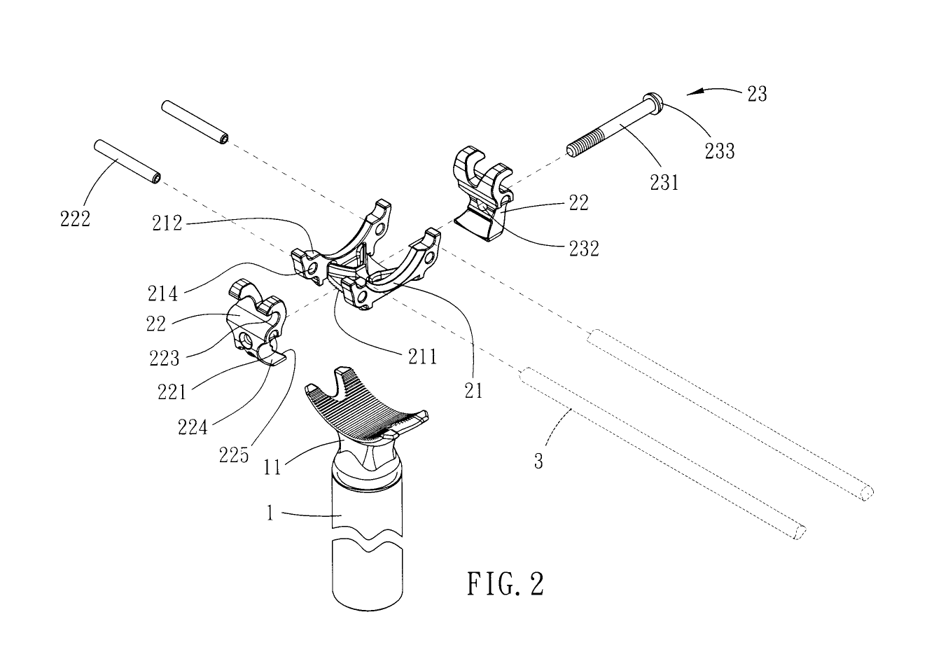

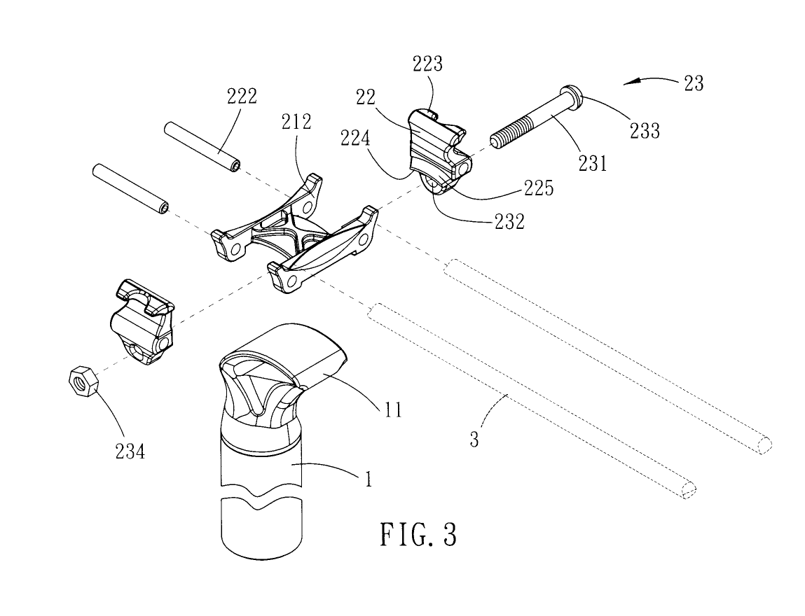

Please refer to FIG. 1 and FIG. 1A. A seat tube of the present invention includes a tube member 1 and a fastening device 2 for a bicycle seat pad. Please refer to FIG. 2. The tube member 1 has an upper end, on which a connecting head 11 is formed. The connecting head 11 is adapted for the fastening device 2 to install thereon, and an upper surface thereof can be a protrusive arc surface. Or, the upper surface of the connecting head 11 can be a concave arc surface, as shown in FIG. 3. The upper surface can be formed with grooves to increase friction.

Please refer to FIG. 2. The fastening device 2 includes a base 21, two pawl shanks 22 and a narrowing means 23.

The base 21 has an upper surface and a bottom surface 211. The bottom surface 211 tightly abuts against the upper surface of the connecting head 11, and the bottom surface 211 may also correspondingly formed with grooves. The base 21 is formed with two hook portions, each of which includes two arms 212. More specifically, the hook portions are disposed on both sides of the base 21 respectively. Among each hook portion, one of the arms is disposed at the front portion of the base 21, and the other arm is disposed at the rear portion of the base. In other possible embodiments of the present invention, each hook portion may include only one arm or more than two arms.

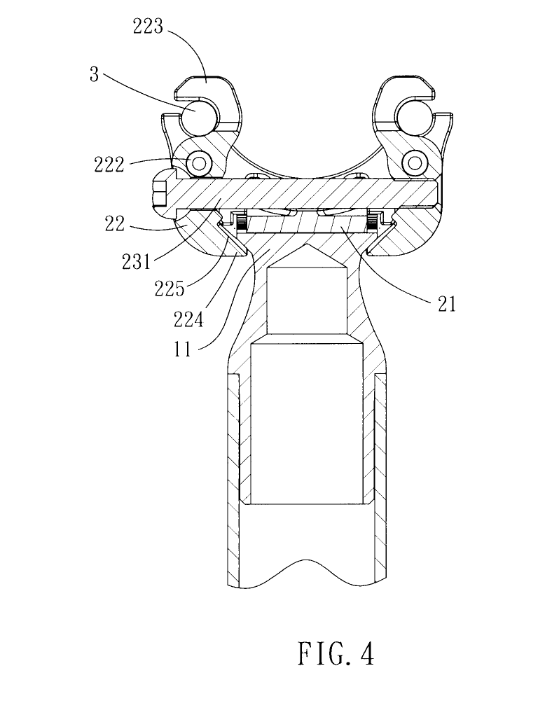

The pawl shanks 22 are pivotable with respect to the base 21. More specifically, the base 21 is formed with two base positioning holes 214, each of which penetrates the arms 212 of each hook portion, and each pawl shank 22 is formed with a pawl positioning hole 221. Each pawl shank 22 is disposed between the arms 212 of a hook portion, thus the base positioning holes 214 communicate with the pawl positioning holes 221 respectively. Two positioning rods 222 are provided to insert the base positioning holes 214 and their corresponding pawl positioning holes 221 respectively, such that the pawl shanks 22 are pivotable about the positioning rods 222 respectively. In other possible embodiments of the present invention, the positioning rods may be replaced by positioning nodes formed on the base or the pawl shanks so as to pivot the pawl shanks to the base. The pawl shanks include an upper hook section 223 and a lower pawl section 224. Each hook section 223 and the arms 212 of its corresponding hook portion define a pad clamp, and the two pawl sections define a tube clamp. Please refer to FIG. 4. Each pawl section has an abutting surface 225 to abut against the connecting head 11, while the abutting surface 225 is slanted.

The narrowing means 23 is adapted for narrowing the pad clamps and the tube clamp. More specifically, the narrowing means 23 may include a screw 231, a through hole 232 and a threaded bore. The screw 231 has a head 233 and a threaded rod axially extended from the head 233. The through hole 232 is formed on one of the pawl shanks, and the threaded bore is formed on the other pawl shank. The threaded rod is inserted through the through hole 232 and then threaded with the threaded bore. Thus as the screw 231 rotates, the pawl shanks are driven to slightly pivot about the positioning rods 222 respectively, narrowing or enlarging the pad clamps and the tube clamp. Please refer to FIG. 3. In another embodiment of the present invention, the fastening means includes a screw 231, two through holes 232 and a nut 234. The through holes 232 are formed on the pawl shanks 22 respectively, and the threaded rod is inserted through the through holes 232 and then threaded with the nut. As such, the pawl shanks 22 can also be urged to pivot, narrowing or enlarging the pad clamps and the tube clamp. Therefore, the pad clamps are adapted to clamp two bottom tubes 3 of a bicycle seat tube, as shown in FIG. 4, and the tube clamp is adapted to clamp the connecting head 11.

It is noted that when the fastening device is under assemblage, the pawl shanks is rotatably and can be easily held by the user due to the positioning rods. As such, the installation of the fastening device and the bicycle seat pad can be facilitated.

What is claimed is:

1. A fastening device for a bicycle seat pad, comprising:
a base, being formed with two hook portions and two base positioning holes;
two pawl shanks, each of which is formed with a pawl positioning hole, each pawl shank comprising a pawl section and a hook section;
two positioning rods, each of which inserts in one of the base positioning holes and the pawl positioning hole of one of the pawl shanks, such that the pawl shanks being pivotable about the positioning rods respectively;
wherein each hook portion and its corresponding hook section define a pad clamp, the pawl sections define a tube clamp;
a means for narrowing the pad clamps and the tube clamp.

2. The fastening device of claim 1, wherein the means for narrowing comprises a screw, a through hole and a threaded bore, the screw has a head and a threaded rod axially extended from the head, the through hole is formed on one of the pawl shanks, the threaded bore is formed on the other pawl shank, the threaded rod is inserted through the through hole and threaded with the threaded bore.

3. The fastening device of claim 1, wherein the means for narrowing comprises a screw, two through holes and a nut, the screw has a head and a threaded rod axially extended from the head, the through holes are formed on the pawl shanks respectively, the threaded rod is inserted through the through holes and then threaded with the nut.

4. The fastening device of claim 1, wherein each pawl section has an abutting surface, the abutting surface is slanted.

5. The fastening device of claim 1, wherein each hook portion comprises two arms, each base positioning hole is defined on the arms of each hook portion, each pawl shank is disposed between the arms of each hook portion, each pad clamp is defined by the hook section and the arms of each hook portion.

6. A seat tube having a fastening device of claim 1, further comprising a tube member, the tube member having an upper end, a connecting head is formed on the upper end, the connecting head is clamped by the tube clamp.
